(19) United States
(12) Patent Application Publication
(10) Pub. No.: US 2006/0142419 A1
(43) Pub. Date: Jun. 29, 2006

(54) Cured compositions containing fine magnetic particles and a process for preparing same and their use

(76) Inventors: Jingjing Xu, Wilmington, DE (US); Charles J. Molnar, Wilmington, DE (US); Shekhar Subramoney, Hockessin, DE (US); Michael K. Crawford, Glen Mills, PA (US); John S. Gergely, Avondale, PA (US); Lu Zhang, Midlothian, VA (US); Edwin S. Marston, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/251,259

(22) Filed: Oct. 14, 2005

Related U.S. Application Data
(60) Provisional application No. 60/619,310, filed on Oct. 14, 2004.

(51) Int. Cl. C09D 11/00; C09D 5/00

(52) U.S. Cl. 523/161; 977/900

(57) ABSTRACT

The present invention is a dispersion composition comprising (1) a curable mixture of monomers, oligomers, or a combination thereof; and (2) superparamagnetic particles dispersed in the mixture of part (1) and a method for preparing such superparamagnetic particles. The composition of the present invention can be useful as a tool for detecting and/or deterring theft, counterfeiting, or the like in commercial transactions.

This application claims the benefit of U.S. Provisional Application No. 60/619,310, filed Oct. 14, 2004.

### BACKGROUND OF THE INVENTION

1. Field of the Invention

The present invention relates to compositions containing fine magnetic particles and a process for preparing them. It also relates to methods for the use of the compositions for detecting the occurrence of fraud in transactions involving marked articles. More particularly, the present invention relates to methods for marking articles and packaging with magnetically encoded information, and specifically methods that significantly increase the density of the encoded information therein.

2. Description of the Prior Art

In order to prevent fraud during the conduct of commerce, it has become conventional to mark articles of commerce in some manner, in order to identify the article and/or verify that the article is authentic and has been made and/or sold legally. Legitimate businesses such as manufacturers, suppliers, distributors, and/or vendors are concerned with the growth of various fraudulent practices in commercial transactions. Examples of fraudulent practices that are of concern to legitimate businesses include diversion, dilution, and counterfeiting. Perpetrators of fraud (hereinafter, perpetrators) use illicit tactics to divert profits from legitimate business concerns, and these tactics can also include theft of the authentic goods.

For example, diversion is a practice whereby authentic product is diverted from being sold in a market in which the product was intended to be sold at a low market value, but is rerouted by a perpetrator to another market where the product can be sold at a higher market value. Often the market of lower value is a market that is one that is needy but unable to pay the higher market value. Dilution is a fraudulent practice whereby an authentic product is mixed with an inactive ingredient and the product is represented as being identical to an unmixed product. Counterfeiting is producing a copy of an original article and passing it off as an authentic original article, that is, the article that was copied.

Marking is one method that is used to prevent these fraudulent practices. Methods of marking include overt methods, whereby the marked item is identified in such a manner as to make it apparent to an observer (customer, merchant, perpetrator, or the like) that the item is in fact marked. Overt markings can include, for example, bar codes on the external surface of the marked article, fluorescent ink or pigments easily visible to the naked eye; holograms; trademarks; logos; labels; and unique color schemes. Overt marking has the advantage of being readily apparent to a possible perpetrator and/or merchant that the item is identifiable, and thus can discourage fraud. Dovgodco, et al., in U.S. Pat. No. 6,351,537 B1 describes an article having an overt verifiable holographic image.

Covert marking is a marking practice wherein an article is marked using an identifier that is not easily seen by a consumer. A covert method for detection of fraud is described Doljack, in U.S. Pat. No. 6,442,276 B1, wherein is described a method whereby random codes are provided for marked goods and a database of the random codes is kept to confirm or deny authenticity. Cyr, et al., in U.S. Pat. No. 6,138,913, describes covert encoded information detected by fluorescence at wavelengths of about 650 nm when exposed to near infrared radiation, while Kaiser et al., in U.S. Pat. No. 6,477,277, describes taggants in or on an article that are detected by x-ray fluorescence analysis.

Hardwick, et al., in U.S. Pat. No. 6,403,169, describe a magnetic watermark as method to produce a security document with sheet-like plastic substrates wherein the coating layers contain magnetic particles that are oriented by a magnetic field.

Snelling, et al., in WO 03/091953 A2, describe substrates with magnetic and visual security features comprising ferromagnetic particles that have a magnetic remenence in the absence of an applied magnetic field and the coercivity of greater than 100 Oe.

Dean et al., in U.S. Pat. No. 6,741,770 describe polymer compositions complexed with rare earth ions, said ions being the magnetic component.

It can be desirable to provide compositions useful as improved formulations for curable magnetic films, comprising fine paramagnetic and preferably superparamagnetic nanoparticles, having a particle size (diameter) of less than 1 micrometer, maximum achievable magnetic mass susceptibilities, and dispersed in a curable mixture of monomers.

### SUMMARY OF THE INVENTION

In one aspect, the present invention is a composition, which is a dispersion comprising:
(1) a curable mixture comprising (a) monomers, or (b) oligomers, or (c) a combination thereof, wherein the mixture can be cured or polymerized using a curing or polymerizing agent;
(2) superparamagnetic particles dispersed in the mixture of part (1), wherein the superparamagnetic particles have a diameter of less than 1 micrometer;
(3) optionally at least one curing agent or polymerization agent selected from photoinitiators, radiation initiators, chemical initiators, thermally activated initiators, present in an amount of up to about 2 wt %;
(4) one or more components, optionally present in any effective amount, selected from the group consisting of: (i) viscosity modifiers (up to about 40 wt %), (ii) other taggants, and/or (iii) solvents.

In another aspect, the present invention is a film having dispersed therein superparamagnetic particles having a diameter of less than about 1 micrometer.

In still another aspect, the present invention is an article comprising a polymeric film obtained from a curable dispersion comprising superparamagnetic particles, wherein the film comprises superparamagnetic particles having a diameter of less than about 1 micrometer.

In still another aspect, the present invention is a method of preparing a substrate comprising a superparamagnetic film comprising the steps of: (1) applying a superparamagnetic dispersion to a substrate; and (2) curing the dispersion on the surface of the substrate to form the superparamagnetic film, wherein the film comprises superparamagnetic particles having a diameter of less than about 1 micrometer.

In still another aspect, the present invention is a method of preparing a substrate comprising a superparamagnetic film comprising the steps of: (1) curing a curable dispersion comprising (a) either of (i) a mixture of monomers, (ii) a mixture of oligomers, or (iii) a mixture of monomers and a mixture of oligomers, wherein the mixture is cured using a curing agent; (b) superparamagnetic particles dispersed in the mixture of part (a), wherein the superparamagnetic particles have a diameter of less than 1 micrometer; (c) optionally at least one curing agent or polymerization agent selected from photoinitiators, radiation initiators, chemical initiators, thermally activated initiators; and (d) optionally one or more viscosity modifiers, other taggants, and solvents; and (2) applying the film to the substrate.

In still another aspect, the present invention is a method for preparing nanoparticles that comprises treating a carbon-containing compound or compounds and a metal-containing compound or compounds with a direct current (DC) electric arc plasma. The carbon-containing compounds include C₁ to C₅ hydrocarbons, including but not limited to methane, ethane, propane, butane, and pentane. The metal-containing compounds include one or more of the volatile carbonyls of iron [iron pentacarbonyl, Fe(CO)₅] and nickel [nickel tetracarbonyl, Ni(CO)₄], fed as a vapor, and crystalline cobalt [dicobalt octacarbonyl, CO₂(CO)₈] fed as a powder.

### DESCRIPTION OF THE FIGURES

FIG. 1 is a schematic diagram of the bubbler that provides a stream of iron pentacarbonyl vapor in methane. The iron pentacarbonyl, Fe(CO)₅, is contained in a cylinder (1). Methane is fed at valve (2) through a dip tube extending below the liquid level in the cylinder. The cylinder is immersed in a chilled brine bath (3) maintained at about −10° C. The iron pentacarbonyl/methane stream is mixed with additional or make-up methane from source (4) and passed back through the brine bath to provide a chilled iron pentacarbonyl/methane stream at (5) that is fed to a plasma torch reactor. The brine bath temperature and methane makeup volume determine the concentration of iron pentacarbonyl in the methane feed.

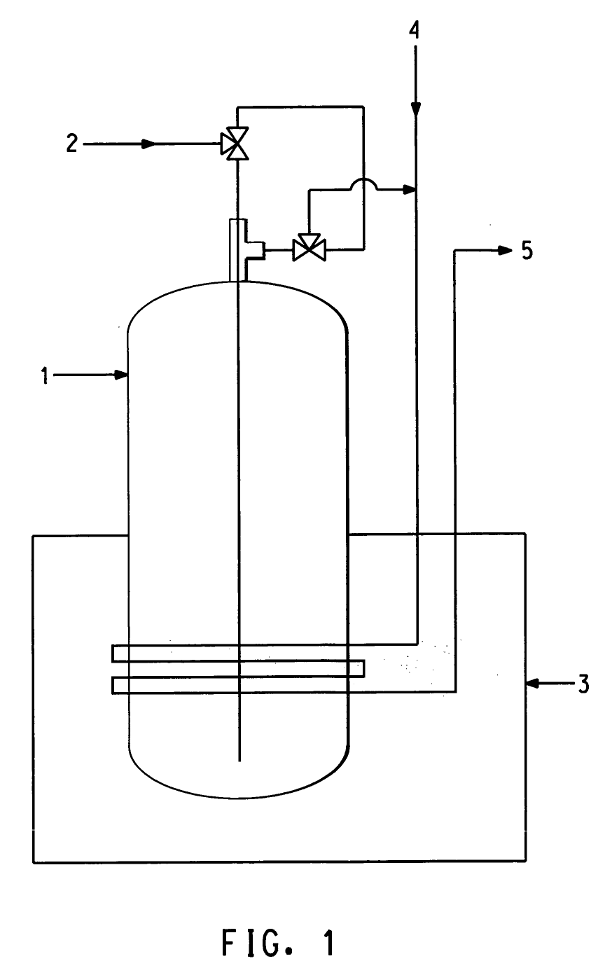

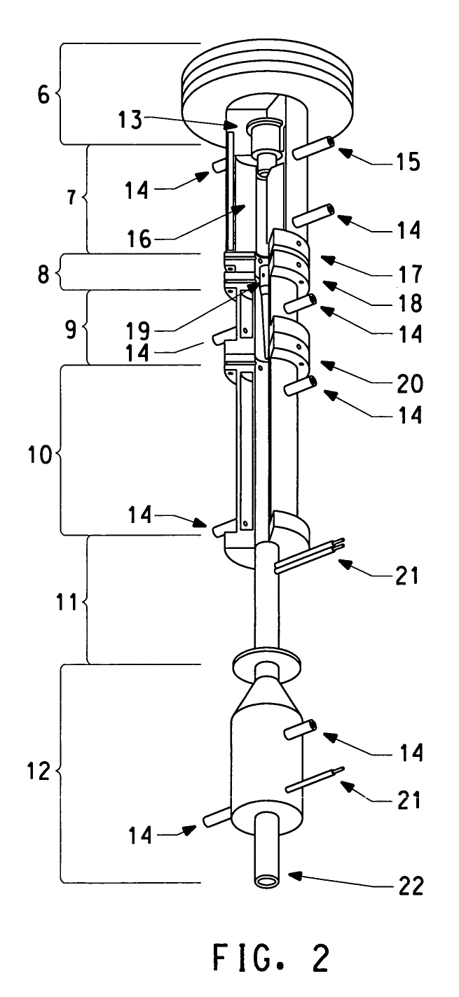

The plasma torch reactor is shown schematically in FIG. 2 and comprises seven sections (6) to (12). An electromagnet (6) surrounds a plasma gun (7) having a cathode (13) and annular anode (16) that generate a plasma. The electromagnet (6) produces an axial magnetic field in the direction of plasma gas flow. This enables rotation of the electric arc between the cathode and anode. Cooling water is admitted and discharged through ports (14). Separately-controlled high purity argon and hydrogen gases are mixed and fed through feed port (15). The plasma gun is attached through a spacer (8) to the nozzle/nozzle holder assembly (9). Spacer feed port (17) admits a methane feed. The water-cooled nozzle holder (18) supports a ceramic nozzle (19). Feed ports on nozzle holder (18) admit the iron pentacarbonyl/methane feed stream from the bubbler (shown in FIG. 1). The nozzle (19) discharges into a quench chamber (10). Helium is introduced through port (20) to aid the quench. The quench chamber is attached through an adapter (11) to the water-cooled product collector (12) containing a fine sintered INCONEL filter (not shown). Provision for connections to pressure transmitters and temperature probes are at (21). Filtered waste gases exit to a scrubber at (22).

### DETAILED DESCRIPTION OF THE INVENTION

Trademarks are shown in upper case.

The term “(meth)acrylate” means either methacrylate or acrylate; the term “(meth)acrylic” means either methacrylic or acrylic.

The terms “superparamagnetic” and “paramagnetic” are used herein. Ferromagnetism is characterized by a long-range ordering of the atomic moments of the material, even in the absence of an external applied magnetic field. The direction of the magnetization with respect to the crystalline axes is determined by forces that are a result of the individual particle shape or crystalline magnetic anisotropy. Below a certain particle size, the magnetization is no longer fixed in a particular direction dictated by particle shape or crystal anisotropy, but ambient thermal energy is large enough to cause the magnetization to jump among different energetically equivalent orientations. Application of a modest external magnetic field will lead to nearly complete alignment of the individual magnetizations of all of the particles, and thus the material will exhibit a large magnetic response. Materials with such properties are referred to as being superparamagnetic, and their particle sizes are typically of the order of 30 nm or less.

A different type of magnetic behavior is paramagnetism, for which the atomic moments are not long-range ordered but can also be induced to align in a common direction by application of a magnetic field. This alignment is generally much less perfect than in a ferromagnet at routinely available magnetic field strengths and at ambient temperature, so the magnetization of a paramagnetic material is generally much smaller than that of a ferromagnetic material when each is measured at equivalent applied magnetic field strengths.

The compositions of the present invention comprise superparamagnetic particles having a diameter of less than 1 micrometer dispersed in a curable mixture comprising (a) monomers, or (b) oligomers, or (c) a combination thereof, wherein the mixture can be cured or polymerized using a curing or polymerizing agent. Said composition optionally further comprises at least one curing agent or polymerization agent selected from photoinitiators, radiation initiators, chemical initiators, thermally activated initiators, and optionally viscosity modifiers, taggants, and solvents.

The term “curable superparamagnetic dispersion” is hereinafter used to describe these compositions. The invention also provides the polymerized or cured dispersion (hereinafter the “cured superparamagnetic polymer”). For the purposes of the present invention, no distinction is made herein between “curing” and “polymerizing”, and either or both processes may be referred to herein simply as “curing”.

The compositions of the present invention comprise superparamagnetic particles that are smaller and easier to disperse without settling than previously described ferromagnetic particles. The small superparamagnetic particles of the present invention provide a means of incorporating more magnetic information into a smaller area, and therefore can be suitable for providing more information on marked articles of commerce.

The curable superparamagnetic dispersions of the present invention are now described in greater detail. The curable or polymerizable monomers and oligomers useful in the practice of the present invention are selected from (meth)acrylate monomers and oligomers and mixtures thereof that polymerize to form poly(meth)acrylates, and other monomers and oligomers that polymerize to form polymers. Alkoxylated multifunctional acrylate monomers (such as ethoxylated 15 trimethylolpropane triacrylate) can be used to accelerate the curing, improve the toughness, and reduce shrinkage of the cured products. Illustrative polymers include epoxy resins, phenoxy resins, cured varnishes, and polyesters, urethanes, and mixtures thereof.

The curable superparamagnetic dispersions of the present invention comprise a matrix in which are dispersed fine paramagnetic or superparamagnetic particles (about 0.01 to about 30% by weight, and preferably from about 0.2% to about 10%, based on the weight of the curable superparamagnetic dispersion. The matrix of the curable superparamagnetic dispersion include a monomer such as methyl (meth)acrylate (MMA, 0 to about 80 wt. %), an alkoxylated multifunctional acrylate monomer (such as ethoxylated 15 triethylolpropane triacrylate (ethoxylated TMPTA), 0% to about 99 wt. %) as a comonomer, a viscosity modifier such as polymethylmethacrylate, PMMA, 0 to about 40 wt. %), and an optional photoinitiator (0 to about 2 wt. %), such that the amounts of monomer and comonomer are not both 0% and that all the components add to 100%. In some cases, curing can be accomplished without incorporating a photoinitiator, and therefore the use of a photoinitiator can be optional, but is preferred.

Preferred fine paramagnetic or superparamagnetic nanoparticles are a metal or a metallic mixture comprising a plurality of metals. Suitable fine paramagnetic or superparamagnetic nanoparticles are transition metals, particularly iron, cobalt, nickel, and their alloys or mixtures. The fine paramagnetic or superparamagnetic particles are preferably superparamagnetic nanoparticles of iron or of mixed iron and cobalt. The primary particle size of the magnetic particles can be less than 1 micrometer, but is preferably 100 nm or less, preferably less than 50 nm, and more preferably less than 30 nm. A notable size range is from about 2 nm to about 30 nm. One particular benefit for using the finer superparamagnetic particles in the present invention is that they can be more easily dispersed in the UV curable composition to provide strong magnetic signals in a limited area.

The magnetic nanoparticles can be coated with carbon or iron oxide, and preferably the nanoparticles are coated with carbon. While not wanting to be bound by theory, the preferred carbon coating or matrix is believed to suppress oxidation of the metallic nanoparticle and to aid dispersion. Suitable nanoparticles for use in the practice of the present invention are described in various publications, including: “Carbon-coated Nanoparticle Formation and Plasma Torch Synthesis” (Majetich et al., ECS/America Proceedings, Fullerenes—Vol. 3 pp. 673-687, 1996); “Carbon Coated Nanoparticle Composites Synthesized in a Plasma Torch” (Scott, et al., Materials Research Society Symposium Proceedings, Vol. 457, pp. 219-224, 1997); Ruoff, et al., in U.S. Pat. No. 5,547,748; Burke et al., in “Magnetic Nanocomposites: Preparation and Characterization of Polymer-Coated Iron Nanoparticles”, (Chem. Mater. 2002, 14, 4752-4761); Geus, in WO 99/46782.

Nanoparticles suitable for use in the practice of the present invention can be made by plasma torch synthesis radio frequency techniques, and are available from the Department of Materials Science and Engineering at Carnegie Mellon University.

In a preferred embodiment, carbon-coated superparamagnetic particles of the present invention are prepared by a direct current plasma process as described in more detail below and in a U.S. Provisional Patent Application entitled “Process for Preparing Superparamagnetic Transition Metal Nanoparticles” filed Oct. 14, 2005, and assigned to E. I. DuPont de Nemours and Company.

The process of the present invention for preparing nanoparticles comprises treating carbon-containing compound(s) and metal-containing compound(s) with a direct current (DC) electric arc plasma. The carbon-containing compounds include C₁ to C₅ hydrocarbons, including but not limited to methane, ethane, propane, butane, and pentane. The metal-containing compounds may be fed as a vapor stream in a hydrocarbon such as methane, as a liquid, or as a powder. Preferred metal compound feeds include one or more of the volatile carbonyls of iron [iron pentacarbonyl, Fe(CO)₅] and nickel [nickel tetracarbonyl, Ni(CO)₄], which may be fed as vapor mixtures in methane or as liquids, and crystalline cobalt [dicobalt octacarbonyl, CO₂(CO)₈], which may be fed as a powder or as a liquid above its melting point of 51° C. The DC arc source that can be used is a plasma torch reactor such as that illustrated in FIG. 2. A plasma gun suitable for use in the reactor is a modified Metco MBN plasma gun having a maximum power of 40 kW and 500 A at 80V. A detailed description of the use of an iron pentacarbonyl/methane vapor source and a plasma torch reactor to produce superparamagnetic carbon-coated iron nanoparticles, having iron particles with size of approximately 5 nm, is given in Example 4 below.

A nickel tetracarbonyl vapor phase source, and/or a dicobalt octacarbonyl source can be used to prepare nanoparticles having iron mixed with nickel and/or cobalt. More preferred materials for the preparation of superparamagnetic carbon-coated iron nanoparticles comprise an iron pentacarbonyl vapor phase source and methane.

In an example of the preparation of the preferred carbon-coated superparamagnetic iron particles by the process of the present invention, a bubbler, shown schematically in FIG. 1, was used to prepare a vapor phase stream containing iron pentacarbonyl, Fe(CO)₅, in methane. Control of the cylinder temperature and a makeup stream of methane enabled control of the vapor composition. The chilled vapor composition was fed to a plasma torch reactor shown schematically in FIG. 2. The plasma torch reactor was placed inside an electromagnet to produce an axial magnetic field in the direction of plasma gas flow. This ensured rotation of the electric arc between the cathode and anode, especially at low gas flow rates. Constant rotation of the arc is needed to prevent anchoring and to provide even wear to the anode. Argon and hydrogen gases were fed through the plasma torch. A methane feed entered the reactor below the exit of the torch and above the nozzle, where the hot argon/hydrogen plasma gases dissociated the methane. The dissociated methane provided the source of carbon to coat the iron. Iron pentacarbonyl readily dissociates above about 250° C., so on entering the reactor it is completely dissociated and provided the source of iron. Nanometer-sized iron particles are formed and coated with a carbon matrix inside the nozzle. The nozzle maintained one-dimensional flow in the axial direction to reduce back-mixing. Reduced back-mixing aided in keeping the particle sizes in the a range of approximately 5 nm. The nozzle also provided a fast quench by converting heat in the particles into accelerated forward motion. Nozzle design factors are discussed by Rao, Heberlein, et al. in Plasma Chemistry and Plasma Processing, 15#4, 581-606, 1995. Below the nozzle holder was a water-cooled quench chamber. Below the quench chamber was a water-cooled, single-filter element product collector. The collector housed a 3 micrometer sintered INCONEL 600 filter element. The carbon-coated nanometer iron particles were collected on the filter and removed for analysis. The use of the plasma torch reactor is described in more detail in Example 4.

The fine paramagnetic or superparamagnetic nanoparticles are included in the curable superparamagnetic dispersion in an amount of from about 0.01% to about 30%, and preferably from about 0.2% to about 10%, based on the weight of the curable superparamagnetic dispersion.

Use of mechanical means, viscosity modifiers, and/or other technologies conventional to those of ordinary skill in the coating art can reduce the potential of the curable superparamagnetic dispersions to separate on standing. High shear processes such as a three-roll mill or a Hoover muller achieve this mixing of the solids and binders and to obtain stable dispersions. An alternative is the use of ultrasonic mixing equipment (such as an Ultrasound Processor UIP 1000, available from Hielscher, Teltow, Germany).

The curable superparamagnetic dispersions of the present invention optionally further contain at least one curing agent or polymerization agent selected from photoinitiators, radiation initiators, chemical initiators, thermally activated initiators present in an amount of up to about 2 wt %; one or more components, optionally present in any effective amount, selected from the group consisting of: (i) viscosity modifiers (up to about 40 wt %), (ii) other taggants and/or (iii) solvents.

Initiators are generally chemical agents that break down or are changed upon exposure to an external influence such as heat, light, or other chemicals, and by this action initiate the curing step. Such initiators can be photo-initiators that are activated by light or, radiation-activated initiators, or chemical initiators, or initiators that are activated by heat. Suitable curing agents or initiators useful in practice of the present invention are those that are commonly used for the polymerization of (meth)acrylates, epoxy resins, and polyesters and are well known to those skilled in the art. For example, an initiator suitable for (meth)acrylate polymers is 1-hydroxycyclohexylphenylketone, (such as IRGACURE 184). Added or ambient moisture may be used to cure urethanes. Curing in the practice of the present invention can also be accomplished using high-energy processes such as electron beam initiation.

Modifiers are optional in the practice of the present invention, but can be preferred depending on the application for which the invention is being utilized. Suitable optional viscosity modifiers are well known to those skilled in the art and can be suitable for use herein. For example, viscosity modifiers suitable for use with curable acrylate systems are acrylate oligomers or polymers such as polymethylmethacrylate with a molecular weight of 350,000.

Luminescent taggants can be mixed with the curable superparamagnetic dispersions of the present invention to provide multiple information storage resources, both overt and covert, in the cured superparamagnetic polymer of the present invention.

Solvents are optional in the practice of the present invention, but are not desirable because they have to be removed and contribute to environmental concerns. The effectiveness of the present invention is not affected by the use of solvents.

Such curable superparamagnetic dispersion compositions are curable by various methods. For instance for a curable superparamagnetic dispersion comprising (meth)acrylates, a tri-wavelength UV lamp is suitable, (254, 302, and 365 nm), or a single wavelength UV lamp (302 nm). A low wattage UV lamp of about 10 watts can be used to effect the cure. For instance, in the Examples an 8 W UVLMS-38, 3UV EL Series UV Lamp, available from UVP, Inc. Upland, Calif. was used to cure the dispersion; similar lamps may be substituted. The curable superparamagnetic dispersions containing curable monomers, curing agents, and optional additives occasionally tend to separate on standing prior to polymerization. Minimal standing time, adjustment of the ratio of monomers such as SARTOMER SR9035 (ethoxylated 15 trimethylolpropane triacrylate, see Materials, below) to any other monomers, and the use of optional viscosity modifiers, provide adequate dispersions for curing under ambient conditions.

Superparamagnetic dispersions comprising epoxy resins can be cured using conventional resin/hardener systems. Conventional resin/hardener systems for use in epoxy resin ink compositions are described, for example, in U.S. Pat. No. 3,607,349.

An electron beam can be used to cure superparamagnetic dispersions comprising radiation-curable phenoxy resins. Conventional phenoxy resin formulations are described in U.S. Pat. No. 4,818,780, for example. Curing by electron beam does not require the inclusion of a photoinitiator.

Irradiation (UV light, electron beam radiation, etc.) can be used to cure superparamagnetic dispersions comprising varnishes, such as can be applied to printed food-packaging films, or radiation-curable varnish systems. Conventional radiation-cured varnishes are described in WO 0194451.

The curable superparamagnetic dispersion compositions of the present invention can be cured by UV light to provide UV-cured films, coatings, or inks and provide high magnetic moments, as is shown in Table 2. The viscosity and cure time of the compositions of the present invention can be adjusted by changing the ratio between MMA, PMMA, ethoxylated 15 trimethylolpropane triacrylate. A stable dispersion formation can be prepared with a high particle content and fast curing.

The cured superparamagnetic polymer of the present invention can be used in various types of carrier liquids, including inks for screen, thermal transfer, flexographic, offset, gravure, and intaglio printing; and varnishes and coatings.

The cured polymer comprising the dispersed superparamagnetic particles provides a plurality of spatially separated and magnetically readable superparamagnetic, particles that provide magnetic information when exposed to an arbitrary large magnetic field.

The invention also provides the use of cured superparamagnetic polymers for magnetic coatings, varnishes, films, and inks—including inks for inkjet devices and other marking or printing devices. The superparamagnetic polymer compositions can be applied to articles to provide information storage and product identification/authentication measures. The compositions can be used for bar codes, packaging, labels and containers. By means of the information encoded by the superparamagnetic polymer compositions, the compositions can be used to provide information in combination with magnetic reader systems to provide anti-theft devices, and devices used for product identification, authentication, and anti-counterfeiting.

Among the many applications for the cured superparamagnetic polymer are documents including passports, money, and security instruments; labeling on various substrates including cellulosic compositions and polymeric compositions such as labels made from polyolefins (polypropylene, polyethylene, etc.), polyesters, polyamides, ethylene copolymers, polyvinyl chloride, polyalkylene terephthalate, polyurethane, and copolymers; packaging including wrappings and packaging substrates; labeling on substrates that are opaque, clear, transparent, semitransparent or a combination thereof; labeling that is invisible or visible or a combination of both; directly labeled products (wherein the printing is directly on the product); carrier spatial information identification, e.g. one- and two-dimensional bar codes and logos; and the like. Such uses of the cured superparamagnetic polymer of the present invention can be detected with a reader system capable of reading magnetic information. The cured superparamagnetic polymer can be used as formulations for curable transparent or semitransparent magnetic film, coating or ink as part of the packaging and also as a marker such as a bar code for product identification and anti-counterfeiting. The cured superparamagnetic polymer may be positioned on the top or surface, under a protective layer, or in a hidden layer. For instance, the cured superparamagnetic polymer can be underneath an upper layer comprising black or other nontransparent layer, rendering the cured superparamagnetic polymer invisible but still detectable by a reader.

### Materials and Test Methods

IRGACURE 184 is available from Ciba Specialty Chemical Corp., Tarrytown N.Y.

SARTOMER SR9035 (ethoxylated 15 trimethylolpropane triacrylate) is available from the Sartomer Company, Exton Pa.

Oleic acid, MMA, MAA, PMMA, were obtained from Sigma-Aldrich, St. Louis Mo.

Barium ferrite was obtained from Toda-Kogyo Corporation (Otake, Hiroshima, Japan) as HEX-UF70/30.

Dysprosium acetate (hydrated) was obtained from Aldrich Chemical, Milwaukee Wis. The material was dried at 130° C. and 80 kPa for 5 days prior to use. The dry material is hygroscopic and should be transferred rapidly to the monomer mixture.

Superparamagnetic samples of carbon coated Fe/Co nanoparticle sized powder and iron oxide coated Fe/Co powders were obtained from Carnegie Mellon University. A sample of each was used, made by radio frequency (RF) plasma torch synthesis and described herein as “Sample A” and “Sample B” respectively.

Iron pentacarbonyl, (195731, Batch # 01114MA) was obtained from Sigma-Aldrich, St. Louis, Mo.

Methane cylinder gas (Ultra-High Purity), helium cylinder gas (Scientific Grade), argon cylinder gas (Ultra-High Purity), and hydrogen cylinder gas (Ultra High Purity) were all obtained from MG Industries, Malvern, Pa.

Test Method 1. Magnetic Measurements

Magnetization measurements were made using a Superconducting Quantum Interference Device (“SQUID”, Model MPMS-XL, manufactured by Quantum Design, San Diego, Calif.

Polycrystalline samples were weighed on an analytical balance and placed in gel capsules that were then suspended in polyethylene tubes in the SQUID sample chamber. Typical sample weights were 10-100 mg. The magnetization measurements (hysteresis loops) were made at a temperature of 300° K. (27° C.). The applied magnetic field was stepped up in increments, starting at zero field and ending at a field well above that needed to saturate the sample magnetization. The field was then stepped down in the same increments to a negative value again sufficient to saturate the sample magnetization, and finally the field sweep was reversed and stepped back up to positive saturation. This generated a hysteresis loop for each sample, from which was determined the magnetization per gram as a function of magnetic field. The saturation magnetization, as well as the magnetization at a field of 100 Oe (7958 A/m), and the coercive fields, were then extracted from the data and are given in Table 2.

### EXAMPLES

### Example 1

To a 50-mL round bottom flask, the required amount of superparamagnetic particles (Sample A, 0.02 g) was added. SARTOMER 9035 (2.00 g) was placed in the flask and the mixture was stirred by hand using a metal stirrer to wet the additive before the monomers were added. MMA (8.00 g) was added and the mixture was vigorously mixed using an air driven mixer with glass rod and Teflon blade until the mixture was well dispersed (about 1 hr). Lastly, IRGACURE 184 (curing agent) was added and the mixture was stirred for an additional 10 minutes. The mixture was quickly transferred to a small aluminum pan (diameter 2 inches, height 1 inch, (5.1×2.5 cm). The liquid depth in the aluminum pan was about 1/16″. The pan was placed under an UV lamp (e.g., a UVLMS-38, 3UV EL Series UV Lamp, 8 W, available from UVP, Inc. Upland, Calif., or equivalent) for a period of 6 hrs at a wavelength of 302 nm to produce an acceptable film for subsequent evaluation of the magnetic properties by Test Method 1. Although these mixtures tended to separate upon standing prior to polymerization, careful adjustment of the ratio of SARTOMER 9035 to MMA listed above provided good the best dispersion under these ambient conditions.

### Examples 2 and 3

Examples 2 and 3 were prepared according to the method of Example 1 except that the components and quantities were varied as shown in Table 1.

### Comparative Example C1

Comparative Example C1 was prepared according to the method of Example 1 except that the components and quantities were varied as shown in Table 1. The high density of the barium ferrite required an increased viscosity to maintain the suspension until cured. The viscosity increase was obtained by the addition of PMMA.

### Comparative Example C2

Comparative Example C2 was prepared according to the procedure of Example 1 except that the components and quantities were varied as shown in Table 1. The dysprosium acetate, a hygroscopic material, was dried for 5 days at 130° C. in a vacuum oven (about 80 kPa). Moisture cannot be present as it will cause a gel to form or make the solution cloudy when added to the recipe. Oleic acid (5.88 g), methyl methacrylate (MMA, 14.50 g), and methacrylic acid (MAA, 3.57 g) were added to a 100-mL three-neck reaction flask. The stirred mixture was heated to 95° C. The dysprosium acetate was transferred directly from the vacuum oven to the flask as quickly as possible and the mixture stirred and heated to 105° C. until clear and free of bubbles. The mixture was cooled and transferred to a glass container to give a clear, light yellow liquid. Clarity was a required property, if the product was cloudy or showed a precipitate on the bottom, as can be caused by moisture, the mixture was discarded and the procedure repeated.

### Comparative Example C3

Comparative Example C3, a control, was prepared according to the procedure of Example 1 except the reaction mixture was MMA (8.00 g, 78.39%), SARTOMER 9035 (2.00 g, 19.60%), and IRGACURE 184 (0.2045 g, 2.00%). No magnetic material or other chemicals were present in this example. The polymerization and testing of magnetic properties was as in Example 1.

TABLE 1
Compositions of Examples 1-3 and Comparative Examples C1 and C2

| | Compositions, (g/% by weight) | | | | |
|---|---|---|---|---|---|
| Component | Ex. 1 | Ex. 2 | Ex. 3 | Ex. C1 | Ex. C2 |
| MMA¹ | 8.00/78.24 | 8.00/76.83 | 8.00/76.93 | — | 14.50/48.30 |
| MAA¹ | — | — | — | — | 3.57/11.89 |
| PMMA^{1,2} | — | — | — | 2.50/24.01 | — |
| SARTOMER | 2.00/19.56 | 2.00/19.21 | 2.00/19.21 | 7.50/72.03 | — |
| 9035 | | | | | |
| Oleic acid | | | | | 5.88/19.59 |
| A³ | 0.02/0.20 | 0.208/2.00 | — | — | — |
| B³ | — | — | 0.208/2.00 | — | — |
| Barium | — | — | — | 0.208/2.00 | — |
| ferrite⁴ | | | | | |
| Dysprosium | — | — | — | — | 6.07/20.22 |
| acetate⁴ | | | | | |
| IRGACURE | 0.2045/2.00 | 0.204/1.96 | | | |
| 0.204/1.96 | 0.204/1.96 | — | | | |
| 184 | | | | | |

¹MMA: methylmethacrylate; MAA: methacrylic acid; PMMA: polymethyl methacrylate, MW: 350,000.
²PMMA provides increased viscosity to aid the suspension of the dense barium ferrite.
³A and B are samples of superparamagnetic Fe/Co nanoparticles coated with carbon (A) and iron oxide (B).
⁴See Materials, above, for sources.

TABLE 2
Magnetic Response of UV Cured Acrylates Loaded with Para-,
Superpara-, and Ferro-Magnetic Tags

| | | Magnetic properties | | |
|---|---|---|---|---|
| | | Mass | Mass | |
| | | magnetization | magnetization | Mass magnetic |
| | Magnetic | at 100 Oe, | at saturation | Susceptibility |
| Ex. # | ingredient | (Am²/kg) | (Am²/kg) | (m³/kg) |
| 1 | 0.2% A⁴ | 0.0029 | 0.1 | 3.64E−07 |
| 2 | 2% A⁴ | 0.11 | 4.9 | 1.26E−05 |
| 3 | 2% B⁴ | 0.034 | 1.8 | 4.27E−06 |
| C1 | 2% Barium | 0.024 | 1.0 | 3.02E−06 |
| | ferrite⁴ | | | |
| C2 | 20% | 0.0035 | No saturation | 4.40E−07 |
| | (CH₃CO₂)₃Dy⁵ | | observed | |
| C3 | None (control) | 0.0 | 0.0 | 0.0 |

⁴See footnotes to Table 1.
⁵For preparation of the anhydrous salt, see Comparative Example C2.

Table 2 shows that 2 wt % carbon-coated Fe/Co nanoparticles (Sample A) showed ˜30 times higher magnetic susceptibility compared with that of 20% Dy salt sample. (1.26E-05 vs. 4.40E-07).

### Example 4

### Preparation of Carbon-Coated Iron Nanoparticles

An iron pentacarbonyl source (bubbler) and plasma torch were used as shown schematically in FIGS. 1 and 2 and as described above. The iron pentacarbonyl, Fe(CO)₅, vapor source comprised a bubbler, which was used to control and limit the feed rate of iron pentacarbonyl (mp −20° C., bp 103° C.). The bubbler consisted of a brine bath, maintained at about −10° C., containing a small cylinder partially filled with iron pentacarbonyl. Methane was fed into the cylinder at a rate of 0.5 L/min. and bubbled through the iron pentacarbonyl to vaporize and carry the iron pentacarbonyl/methane gas-phase stream out of the bubbler. At this point additional methane “make-up” gas at 0.2 L/min. was mixed with the iron pentacarbonyl/methane stream. This mixture was fed back through the brine bath to ensure the gas phase stream was cold when it entered the plasma reactor. The cold gas stream was injected into the nozzle holder where it entered the plasma gas. The feed rate of the iron pentacarbonyl into the reactor was about 22 mg/min. in about 0.7 L/min. methane. The make-up gas was used to ensure that the iron pentacarbonyl penetrated the plasma plume inside the reactor.

The plasma torch reactor, shown schematically in FIG. 2, had a direct current plasma torch, a modified Metco type MBN plasma gun (available from Sulzer Metco Inc., Westbury N.Y.), having a maximum power of 40 kW, 500 A at 80 V. The plasma torch current was set at 110 A. The plasma torch had a water-cooled copper cathode, Metco MB63, and a thoriated tungsten tip water-cooled copper anode, Metco MBN430 (sources as described above). The electromagnet around the torch operated at about 35 V around the torch to produce an axial magnetic field in the direction of plasma gas flow. Argon (ultra high purity, MG Industries, Malvern Pa.) and hydrogen (ultra high purity, also from MG Industries) gases were fed through the torch at 14 and 1.05 L/min., respectively. Below the plasma torch was placed a 1.5-inch (3.8 cm) spacer with three ⅛-inch (3.175 mm) radial feed ports, two capped, and one used to feed methane (ultra high purity, MG Industries) at 0.3 L/min. Below the spacer was placed a 3-inch (7.6 cm) water-cooled nozzle holder containing a 3-inch (7.6 cm) ceramic nozzle (custom made by Insaco, Inc., Quakertown Pa.) and three radial input ports with feed injectors, two capped and the other to feed iron pentacarbonyl (Sigma-Aldrich, St. Louis Mo.) contained in the methane carrier gas.

Below the nozzle holder was a water-cooled quench chamber that had three radial input ports to provide additional quench using helium (scientific grade, MG Industries, see above) fed through each of the ports for a total helium quench of 15 L/min. Below the quench chamber was an adapter connecting the quench chamber to the water-cooled, single-filter element product collector. The collector housed a 3 micrometer sintered INCONEL 600 filter element (from GKN Sinter Metals, Auburn Hills Mich.). The carbon-coated nanometer iron particles were collected on the filter and removed for analysis.

Typically each synthesis constituted multiple shorter runs between which any plugging that occurred at the nozzle or at the methane injection tips was cleared. Specifically for Example 4, a total of 10.7 g of carbon-coated iron particles were produced in 15 h for a production rate of about 0.7 g/h. The reactor was shut down to clear plugging ten times during the synthesis. Run time between plugs was about 30 minutes and product was collected four times from the filter over the course of the 15 h run. The total amount of iron pentacarbonyl fed was 20 g (feed rate 22 mg/min). The reactor pressure at the start and end of the entire run was 812 and 991 Torr (108 and 132 kPa), respectively.

### Example 5

A superparamagnetic sample (Sample C) of carbon-coated Fe nanoparticle powder was prepared by direct current plasma torch synthesis as described in Example 4.

Superparamagnetic particles (Sample C, 3.0 g) were pre-dispersed in SARTOMER 9035 (UV curable monomer, 147.0 g) in a 500-ml beaker. The mixture was ground with 0.2 mm yttrium stabilized zirconia grinding beads (669 g) using an electric motor with a 1-inch (2.54 cm) high-speed disperser (HTD) polyurethane blade (made by Firestone, Indianapolis Ind.) at 3000 rpm for 4 hours. The product after grinding was a dark colored slurry.

To a 50-mL round bottom flask, the required amount of the slurry (0.25 g) was added. Additional UV curable monomer, SARTOMER 9035 (9.75 g), and IRGACURE 184 (curing agent, 0.204 g) were added to the flask and the mixture was stirred by hand using a TEFLON stirrer for 30 min. The mixture was quickly transferred to a small aluminum pan having a diameter of 2 inches and height of 1 inch (5.1×2.5 cm). The liquid depth in the aluminum pan was about 1/16 inch (1.6 mm). The pan was placed under an UV lamp (e.g., a UVLMS-38, 3UV EL Series UV Lamp, 8 W, available from UVP, Inc. Upland Calif.) for a period of 4 h at a peak wavelength of 302 nm to produce a film suitable for subsequent evaluation of the magnetic properties by Test Method 1. Details of the film composition are given in Table 3 and measurements of magnetic properties by Test Method 1 are shown in Table 4.

### Example 6

Example 6 was prepared according to the procedure of Example 5 except the reaction mixture in the 50 ml flask contained slurry (1.00 g), SARTOMER 9035 (UV curable monomer, 9.00 g), and IRGACURE 184 (curing agent, 0.204 g). The polymerization and testing of magnetic properties was as in Example 4. Details of the film composition are given in Table 3 and measurements of magnetic properties by Test Method 1 are shown in Table 4.

TABLE 3
Compositions of Examples 4-5

Compositions,
(g/% by weight)

| Component | Ex. 4 | Ex. 5 |
|---|---|---|
| SARTOMER 9035 | 9.98/98 | 9.95/98 |
| Sample C¹ | 0.005/0.05 | 0.02/0.20 |
| IRGACURE 184 | 0.204/2.0 | 0.204/2.0 |

¹Sample C is a sample of superparamagnetic Fe nanoparticles coated with carbon, prepared as described in Example 4.

TABLE 4
Magnetic Response of UV Cured Acrylates Loaded with
Superparamagnetic Tags

| | | Magnetic properties | | |
|---|---|---|---|---|
| | | | Mass | |
| | | Mass | magnetization | Mass magnetic |
| | Magnetic | magnetization at | at saturation | Susceptibility |
| Ex. # | ingredient | 100 Oe, (Am²/kg) | (Am²/kg) | (m³/kg) |
| 4 | 0.05% C¹ | 0.001 | 0.02 | 0.1E−08 |
| 5 | 0.2% C¹ | 0.0045 | 0.09 | 5.0E−07 |

¹Sample C is a sample of superparamagnetic Fe nanoparticles coated with carbon, prepared as described in Example 4.

Table 4 indicates that the sample with 0.2 wt % carbon-coated Fe nanoparticle (Sample C) showed about the same magnetic susceptibility as that of 20% Dy salt sample described in Comparative Example C2. (5.0E-07 vs. 4.40E-07 m³/kg).

What is claimed is:

1. A composition which is a dispersion comprising:
(1) a curable mixture comprising (a) monomers, or (b) oligomers, or (c) a combination thereof, wherein the mixture can be cured or polymerized using a curing or polymerizing agent;
(2) superparamagnetic particles dispersed in the mixture of part (1), wherein the superparamagnetic particles have a diameter of less than 1 micrometer;
(3) at least one curing agent or polymerization agent selected from photoinitiators, radiation initiators, chemical initiators, thermally activated initiators optionally present in an amount of up to about 2 wt %;
(4) one or more components, optionally present in any effective amount, selected from the group consisting of: (i) viscosity modifiers (up to about 40 wt %), (ii) other taggants, and/or (iii) solvents.

2. The composition of claim 1 wherein the superparamagnetic particles have a diameter of 100 nanometers or less.

3. The composition of claim 2 wherein the superparamagnetic particles have a diameter of less than 50 nm.

4. The composition of claim 3 wherein the superparamagnetic particles have a diameter of less than 30 nm.

5. The composition of claim 4 wherein the superparamagnetic particles are present in an amount of from about 0.01 to about 30 wt % of the weight of the dispersion.

6. The composition of claim 5 wherein the superparamagnetic particles are present in an amount of from about 0.2 to about 10 wt %.

7. The composition of claim 1 wherein the superparamagnetic particles are metal or a mixture of metals.

8. The composition of claim 7 wherein the superparamagnetic particles comprise iron.

9. The composition of claim 8 wherein the superparamagnetic particles comprise iron and cobalt.

10. The composition of claim 1 wherein the superparamagnetic particles are coated with carbon or with iron oxide.

11. The composition of claim 6 wherein the superparamagnetic particles are coated with carbon or with iron oxide.

12. The composition of claim 11 wherein the dispersion further comprises a curing agent.

13. The composition of claim 12 wherein the curing agent is an initiator selected from the group consisting of: photo-initiators; chemically activated initiators; radiation-activated initiators; or heat-activated initiators.

14. The composition of claim 13 wherein the initiator is 1-hydroxycyclohexylphenylketone.

15. The composition of claim 13 wherein the initiator is water.

16. The composition of claim 11 wherein the composition does not include an initiator.

17. The composition of claim 11 wherein the composition comprises a viscosity modifier.

18. The composition of claim 17 wherein the viscosity modifier is poly(methylmethacrylate).

19. The composition of claim 1 wherein the curable mixture comprises (meth)acrylate monomers.

20. A film having dispersed therein, superparamagnetic particles having a particle size of less than about 1 micrometer.

21. An article comprising a film or a coating wherein the film or coating has dispersed therein superparamagnetic particles having a diameter of less than 1 micrometer.

22. The article of claim 21 wherein the article is a label attached to an article of commerce.

23. The article of claim 21 wherein the article is a package used to package an article of commerce.

24. The article of claim 21 wherein the film or coating is a barcode.

25. The article of claim 21 wherein the film or coating contains information.

26. A method of applying a film having superparamagnetic particles dispersed therein comprising the step of printing onto a substrate, a dispersion comprising: (1) a curable mixture comprising (a) monomers, or (b) oligomers, or (c) a combination thereof, wherein the mixture can be cured or polymerized using a curing or polymerizing agent; (2) superparamagnetic particles dispersed in the mixture of part (1), wherein the superparamagnetic particles have a diameter of less than 1 micrometer; (3) optionally at least one curing agent or polymerization agent selected from photoinitiators, radiation initiators, chemical initiators, thermally activated initiators, present in an amount of up to about 2 wt %; (4) one or more components, optionally present in any effective amount, selected from the group consisting of: (i) viscosity modifiers (up to about 40 wt %), (ii) other taggants, and/or (iii) solvents.

27. The method of claim 26 wherein the printing step is an ink-jet or screen printing process.

28. A method of preparing a substrate comprising a superparamagnetic film comprising the steps of: (1) applying a superparamagnetic dispersion to a substrate; and (2) curing the dispersion on the surface of the substrate to form the superparamagnetic film, wherein the film comprises superparamagnetic particles having a diameter of less than about 1 micrometer.

29. A method for preparing a substrate comprising a superparamagnetic film comprising the steps of: (1) curing a curable dispersion comprising (a) either of (i) a mixture of monomers, (ii) a mixture of oligomers, or (iii) a mixture of monomers and a mixture of oligomers, wherein the mixture is cured using a curing agent; (b) superparamagnetic particles dispersed in the mixture of part (a), wherein the superparamagnetic particles have a diameter of less than 1 micrometer; (c) optionally at least one curing agent or polymerization agent selected from photoinitiators, radiation initiators, chemical initiators, thermally activated initiators; and (d) optionally one or more viscosity modifiers, other taggants, and solvents; and (2) applying the film to the substrate.
